(19) United States
(12) Patent Application Publication
(10) Pub. No.: US 2009/0107928 A1
(43) Pub. Date: Apr. 30, 2009

(54) Paint spray booth sludge consolidation method and apparatus

(76) Inventors: Kevin E. Coursin, Crystal Lake, IL (US); Steve E. Telchuk, Mundelein, IL (US)

Correspondence Address: PYLE & PIONTEK LLC, 221 N. LASALLE STREET, SUITE 1207, CHICAGO, IL, 60601, US

(21) Appl. No.: 12/288,361

(22) Filed: Oct. 20, 2008

Related U.S. Application Data
(60) Provisional application No. 61/000,712, filed on Oct. 26, 2007.

(51) Int. Cl. C02F 1/38; C02F 103/14

(52) U.S. Cl. 210/787; 210/512.1; 210/257.1; 210/194

(57) ABSTRACT

A method and apparatus is disclosed for eliminating the bagging of paint spray booth sludge, and instead, centrifuging the collected sludge, re-watered if need be for transport, into a high solids content sludge and water for holding the sludge in suspension upstream of the centrifuge and apparatus for accomplishing the same.

### DISCLOSURE

This application is a United States Non-Provisional patent application claiming the benefit and priority of Provisional patent application, Ser. No. 61/000,712, filed on Oct. 26, 2007 and relates to a method and apparatus for paint sludge consolidation and more particularly to an improved method and apparatus utilizing centrifugal consolidation adapted to replace a gravitational bag consolidator.

### BACKGROUND OF THE INVENTION

It is known to collect the overspray from paint spray booths by causing the overspray to agglomerate into a sludge which is directed to and collected in a generally water filled tank and either floats or is treated to float. The water may include certain known chemicals to facilitate agglomeration. This floating agglomerated sludge is then removed from the surface of the water in the tank by some type of skimmer or surface rake. The material collected by the rake is usually very wet and is sent into a bag and permitted to drain for a period of time to reduce the moisture content. Even so the moisture content stays quite high and the bagged sludge is still a considerable mess and must be physically removed and disposed of. This system requires continued use of bags and is inconvenient in use.

### SUMMARY OF THE INVENTION

The disadvantage of the above bag type consolidator has been overcome by the improved method and apparatus of the present invention for consolidating paint spray booth sludge. The method and apparatus of the present invention comprises the steps and means for receiving the agglomerated sludge raked off of the water tank, or otherwise collected, and then, if need be, re-watering the sludge to transport the same, then centrifuging the sludge and water to separate the sludge from the water, using the separated water to facilitate the transportation, centrifuging the sludge to a high solids matter say a 40% or above, and preferably to a solids state of 45% or 50% or greater, and returning the separated water upstream to keep system or even the source of sludge clean, keeping any sludge from accumulating thereon so that all or at least almost all such sludge is removed by the centrifuge, for cleaner and more economical disposal.

### BRIEF DESCRIPTION OF THE DRAWINGS

FIG. 1 is a schematic for a first embodiment of method and apparatus of the present invention.

FIG. 2 is a further improvement of second embodiment of the method and apparatus of the present invention.

### DESCRIPTION OF THE PREFERRED EMBODIMENTS

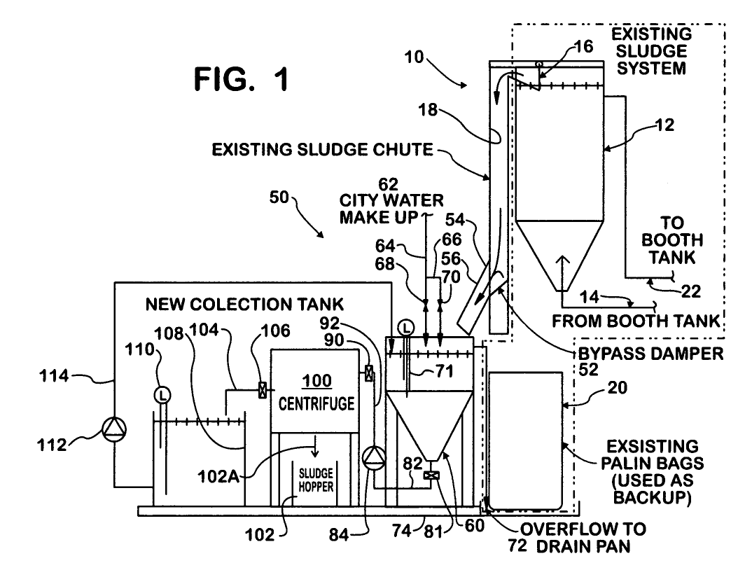

Referring to FIG. 1, a prior art sludge collection system 10 is shown in conjunction with the present invention 50.

The prior art device 10 includes a tank 12, to which paint overspray or sludge collected in paint spray booths, upstream and not shown, is sent, indicated by the arrow 14. The sludge is generally conditioned to float in tank 12. The sludge is removed from the top of the tank 12 by a skimming or raking mechanism 16 and discharged into the chute 18, wherein the device of the prior art, it was allowed to fall into and collected in a bag 20. The wet sludge in the bag 20 drains through openings in the fabric thereof and eventually is disposed of and a new bag put in place. Excess water is returned from the upper portion of tank 12 to the spray booth paint overspray sludge collection system, as indicated at 22.

In the present invention and in the FIG. 1 embodiment, the above described system is modified to provide a diverter baffle or bypass 52 and opening 54 in the sidewall of the chute 18. The bypass includes a chute extension 56, which discharges the wet sludge indicated by the arrow 58, formerly collected in the bag, to a collector tank 60.

For purposes of ensuring transportation of the sludge 58 that falls into the tank 60, more water may be added if needed, from the city water supply, indicated by 62 through two pipes 64 or 66. One of the passages or pipes 64 is filled with an automatic solenoid fill valve 68 (controlled by water level detecting means 71) and the other pipe 66 with a manual fill valve 70. The tank 60 is also provided with the level control system 71, which could be on the order of a float valve. Any excess water in the tank can be sent to a drain 72 and drain pan 74 if need be. As sludge is removed from the system by the centrifuge additional water may be needed to keep up the water level. Should any additional water be needed, it could be provided by the system and pipes 64 or 66.

The sludge to be de-watered and accompanying transporting water is withdrawn from the tank 60, through a valved 81 pipe 82 by a pump 84. The pump 84 discharges this water sludge mixture through a valved 90 pipe 92, into a centrifuge 100.

The relatively dry centrifuged sludge indicated by the arrow 102A drops into a hopper or basket 102, while the water cleaned by the centrifuge flows through a pipe 104, via valve 106 into a recovery tank 108. The tank 108 has a level mechanism 110 which is used to control a pump 112 in the pipe 114. The pump 112 sends the recovered clean liquid back into the tank 60 to keep the sludge dropped into that tank in suspension and to prevent it from collecting therein. Thus, the tank 60 and generally the entire system 50 is clean running and self cleaning and needs little or no maintenance.

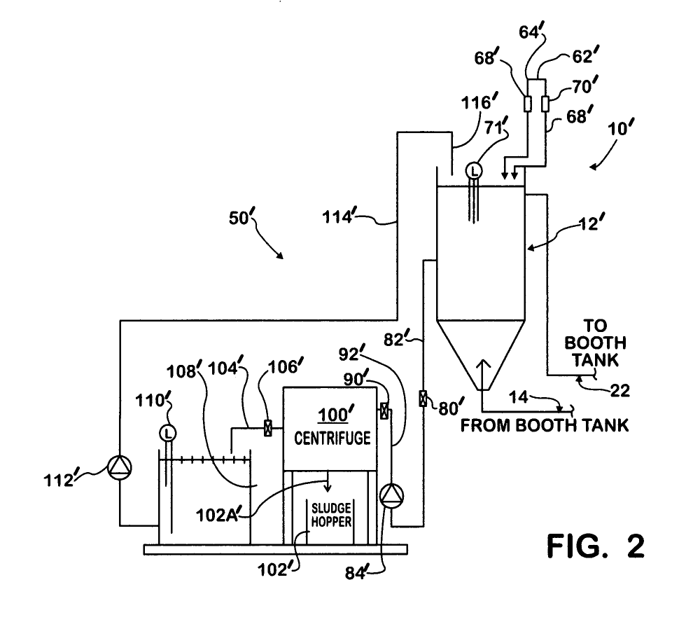

Referring to FIG. 2 a simplified and less complicated embodiment of the method and apparatus of the present invention as shown, and where similar the same reference numerals are used for the prior art portions and primed reference numerals are used for the new elements.

This embodiment 10′ includes the tank 12′ which is similar to the tank 12 of FIG. 1, except the chute 18 and raking mechanism 16 are not used and/or removed to make the system simpler and easier to maintain. Now the sludge from pipe 14 is sent into the tank 12′ and generally kept in suspension with the centrifugal return flow from the pump 112′, in pipe 114′. The suspended sludge is drawn out of the tank 12′ via the pipe 82′ and pump 84′ and supplied to the centrifuge 100′ to separate the sludge 102A′ and the return water supplied to the pump 112′. A level control 71′ similar to the level control 71 of FIG. 1 can be provided. If need be make up water can be supplied from the source 62′, via pipes 64′ or 66′, through solenoid fill valve 68′ or a manual fill valve 70′, to the tank 12′, in a manner similar to that for 62, 64, 66, 68 and 70 for the tank 60 of FIG. 1.

In operation the embodiments of FIGS. 1 and 2 are similar in that the sludge is collected from tank 12 or 12′, sent to a centrifuge 100 or 100′ separating the sludge 102A or 102A′ and returning the water via pump 112 or 112′ to the tank 60 or 12′ to keep the sludge in suspension so it can be pulled out via pipe 82 or 82′ by the pump 84 or 84′ and sent to the centrifuge 100 or 100′.

The present invention, thus, eliminates the prior bagging process and use and consumption of bags for the same while producing a much dryer, more compacted sludge which can be more easily and cleanly disposed of.

With respect to sizing some of the components, they are matched to the booth or booths serviced. For example, see U.S. Pat. No. 6,682,654, inventor Steve E. Telchuk, issued Jan. 27, 2004 entitled “Sludge Recovery Apparatus and Method” and U.S. Pat. No. 6,979,399, inventor Steve E. Telchuk, issued Dec. 27, 2005 entitled “Sludge Recovery Apparatus and Method” which are incorporated herein by reference herein by reference.

While several embodiments were shown it is understood that equivalent steps and elements to those in the following claims are within the scope of the invention.

What is claimed is:

1. A method for treating sludge from a paint spray booth that had utilized a bagging operation, comprising the steps of:
one of disabling or removing the bagging operation,
transporting the sludge to a centrifuge,
re-watering the sludge if necessary to facilitate tranporting,
centrifuging the sludge to separate into high solids content sludge and water, and
utilizing the water to keep the sludge in suspension upstream of the centrifuge and prevent it from collecting before centrifuging.

2. A method as in claim 1, including the step of disabling said spray booth bagging operation.

3. A method as in claim 1, including the step of providing a diverting chute upstream of the bagging operation, and delivering the sludge by the diverting chute for the transporting step to the centrifuge.

4. A method as in claim 3, including providing a collection tank below said diverting chute for receiving the sludge.

5. A method as in claim 4, including the steps of withdrawing the sludge from said collection tank and transporting it for centrifuging.

6. A method as in claim 5, comprising the step of centrifuging the sludge includes separating the sludge from excess water and returning the excess water to the collection tank, and using the returning and excess water for cleaning the collection tank.

7. A method as in claim 1, including the step of removing bagging operation.

8. A method as in claim 7, including the step of providing a diverting chute upstream of the removed bagging operations, and delivering the sludge by the′diverting chute for the transporting step.

9. A method as in claim 1, wherein the paint spray booth includes a booth collection tank that collects sludge from the spray booth, a rake on the booth collection tank surface discharge chute for delivering the raked sludge to the bagging operation, comprising the steps of removing the rake and discharge chute, and transporting the sludge from the spray booth collection tank to the centrifuge.

10. A method for treating sludge from a paint spray booth, comprising the steps of:
collecting the sludge from the paint spray booth in a tank,
transporting the sludge to a centrifuge,
re-watering the sludge if necessary to facilitate transporting,
centrifuging the sludge into high solids content sludge and water, and
two or more of utilizing the water to:
keep the paint spray booth clean, keep the sludge from the paint spray booth in suspension upstream of the centrifuge, and prevent sludge from collecting before centrifuging.

11. An apparatus for collecting sludge from a paint spray booth that bagged sludge, comprising:
means for collecting the sludge from the paint spray booth,
means for re-watering the sludge to facilitate its transport,
centrifuge means for separating the sludge into high solids content sludge and water, and
means for returning the water to hold the sludge in suspension upstream of the centrifuge means.

12. An apparatus as in claim 11, wherein said spray paint booth includes a spray booth chute discharging sludge into a bag, an opening provided in said spray booth discharge chute to discharge said sludge to said centrifuge.

13. An apparatus as in claim 12, further including a collection tank, said collection tank being located to receive sludge from said opening in said spray booth discharge chute.

14. An apparatus as in claim 12, wherein said opening is located in an upper portion of said spray booth discharge chute, and said spray booth discharge chute below said opening is closed.

15. An apparatus as in claim 11, wherein said spray booth includes a spray booth collecting tank receiving sludge from said spray booth, a rake system on the top of said spray booth collection tank and a discharge chute receiving the sludge from said raking system, said discharge chute being capable of discharging the sludge into a bag, an opening provided in said discharge chute to divert sludge from said discharge chute, a bypass damper provided in said discharge chute below said opening to selectively close off or open said discharge chute to said bag, a second collection tank receiving said sludge diverted through said opening from said discharge chute.

16. An apparatus as in claim 15, further including piping for delivering sludge and water from said second collection tank to said centrifuge means.

17. An apparatus as in claim 16, further including further piping for delivering water from said centrifuge means back to said second collection tank to keep the sludge in suspension and said apparatus clean.

18. An apparatus as in claim 17, further comprising a centrifuge water discharge tank for collecting water from said centrifuge, and a pump for pumping said water from said centrifuge water discharge tank back to said second collection tank.

19. An apparatus for treating paint spray booth discharging sludge and water, comprising: a collection tank receiving sludge and water from said spray booth, a centrifuge connected to withdraw water and sludge from the collection tank, said centrifuge separating the sludge from the water, a sludge hopper below said centrifuge for receiving the separated sludge from said centrifuge, a centrifuge water collection tank for receiving water separated by said centrifuge, a pump for receiving water from said centrifuge water collection tank and pumping it back to said collection tank to keep the sludge in suspension and said collection tank clean.

20. An apparatus as in claim 19, including water leveling means for adding water to said apparatus to make up for water discharge with said sludge in said sludge hopper.

21. An apparatus as in claim 11, including water leveling means for adding water to said apparatus to make up for water discharged from said apparatus.
